(19) United States
(12) Patent Application Publication
(10) Pub. No.: US 2005/0017675 A1
(43) Pub. Date: Jan. 27, 2005

(54) Hub Structure having a charging function

(76) Inventors: Potter Hsieh, Taipei (TW); Jason Chen, Taipei (TW)

Correspondence Address: PRO-TECHTOR INTERNATIONAL, 20775 Norado Court, Saratogo, VA, 95070-3018, US

(21) Appl. No.: 10/621,659

(22) Filed: Jul. 16, 2003

(51) Int. Cl. H02J 7/00

(52) U.S. Cl. 320/107

(57) ABSTRACT

The present invention relates to a hub structure having a charging function. The structure is a combined structure formed by integrating a conventional charging holder/device and a hub so as to provide the direct current to a wireless mouse, wireless indexer, wireless keyboard, or wireless device of the general computer. This will avoid the trouble of installing or replacing the battery of the wireless peripheral device for the computer. Besides, each of the wireless keyboard, the wireless mouse and the wireless device has to be provided with a receiving device to be connected to the computer. Therefore, the present invention is used for being connected to the wireless keyboard and the wireless mouse so as to reduce the cost, promoting the efficiency and provide the convenience to the consumer.

### BACKGROUND OF THE INVENTION

1. Field of the Invention

The present invention relates to a low-cost and easy-use hub structure having a charging function. The structure is formed by integrating a charging holder/device and a hub so as to be connected to the peripheral device for the computer, such as a wireless keyboard, a wireless mouse or a wireless device. The structure is also used for supplying the direct current to the peripheral device for the computer. Therefore, the cost can be reduced, the efficiency promoted, and the user is provided with more convenience.

2. Description of the Prior Art

As the technology advances, the society getting more prosperous, and the incomes gradually increase, the living quality improves and people are more concerned about the electric equipments used at home. The computer almost becomes a requisite for every family, and the computer plays an important role in every person's living. As the network age is coming, everyone surfs on the network, such as the Internet. The user can use the computer or the mobile phone to connect to the Internet, and the computer is the most used for the Internet connection.

In addition, the peripheral devices for the computer are various, and their structures are developed from wired to wireless ones. The wireless device also gets more diverse. For example, the wireless device can be a wireless keyboard, a wireless mouse, a wireless indexer, and so on. However, it is an important issue to consider the power supply for the wireless device. Generally, the wireless device has a chargeable or dischargeable battery for supplying the power. Because of the concerns for the environment conservations, the charging battery is widely used. Therefore, the charging holder/device becomes a requisite. The most popular ones comprise a charging holder/device for directly connecting and receiving the mains supply, a charging holder/device for directly connecting and receiving the direct current converter, and a charging holder/device for directly connecting and receiving the power supply of the computer. In any case, an additional and exclusive charging holder/device is required, and the external space has to be occupied. Therefore, how to effectively avoid the mentioned drawbacks is the main issue for the business.

### SUMMARY OF THE INVENTION

Therefore, the object of the present invention is to provide a hub structure having a charging function. The hub structure is a combined structure formed by integrating a conventional charging holder/device and a hub so as to be connected to a wireless mouse, wireless indexer, wireless keyboard, or wireless device of the general computer, and to provide the direct current to them. This will avoid the trouble of installing or replacing the battery of the wireless peripheral device for the computer. Besides, each of the wireless keyboard, the wireless mouse and the wireless device has to be provided with a receiving device to be connected to the computer. Therefore, the present invention is used for being connected to the wireless keyboard and the wireless mouse so as to reduce the cost, promoting the efficiency and provide the convenience to the consumer.

The main characteristic of the hub structure having a charging function according to the present invention is that the hub structure comprises a body and a transmission line. The transmission line is connected to one side of the body having an interface of USB, PS2 or serial communication connection port. The greatest side of the body is formed with a battery tray, and at least one charging battery is installed in the battery tray. In order to prevent the battery from falling off, a battery tray cover is installed above the battery tray for covering the battery tray. At least one connecting hole is installed on one side of the body, and the connecting hole has an interface of USB, PS2 or serial communication connection port. The connecting hole and the transmission line are separately connected to the inside circuit structure of the body so as to form the hub structure having a charging function.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a hub structure according to the present invention;

FIG. 2 is a perspective diagram of the hub structure separated from the connection lines;

FIG. 3 is a perspective diagram of the hub structure connected to the connection lines;

FIG. 4 is a perspective diagram of another embodiment according to the present invention; and

FIG. 5 is a block diagram of the circuit structure according to the present invention.

### DETAILED DESCRIPTION OF THE PREFERRED EMBODIMENT

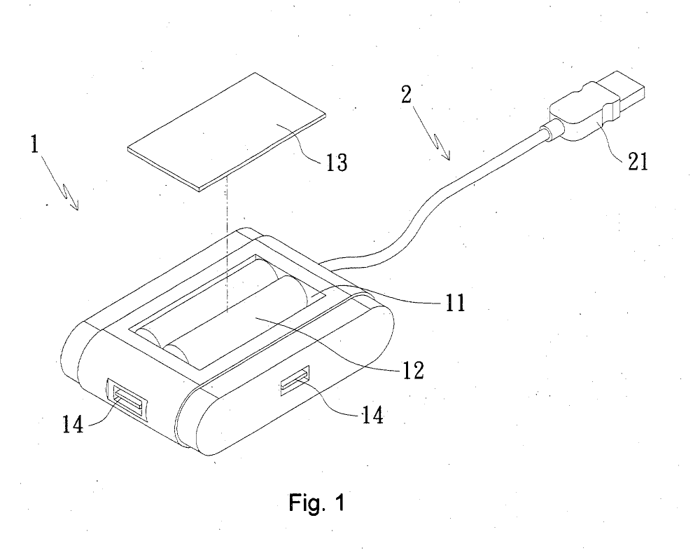

First, please refer to FIG. 1. FIG. 1 is a perspective diagram of a hub structure according to the present invention. The hub structure comprises a body 1 and a transmission line 2. One end of the transmission line 2 is connected to one side of the body 1, and the other end is a connecting head 21, which is an interface of USB, PS2 or serial communication connection port. The connecting head 21 is inserted into the corresponding connection port of the computer so that the computer can supply power to the structure. The body 1 is a rectangular body having arc-shaped profile. The greatest side of the body 1 is formed with a battery tray 11, and at least one charging battery 12 is contained in the battery tray 11. In order to prevent the battery from falling off, a battery tray cover 13 is installed above the battery tray 11 for covering the battery tray 11. At least one connecting hole 14 is installed on the side of the body 1, and the connecting hole 14 can be an interface of USB, PS2 or serial communication connection port. The connecting hole 14 is also used for being the corresponding connection portion to be connected to the peripheral device for the computer, such as a wireless keyboard, a wireless mouse or a wireless device. In addition, the hub structure supplies the power to the peripheral device for the computer. The connecting hole 14 and the transmission line 2 are separately connected to the circuit structure of the body 1 so as to form the hub structure having a charging function.

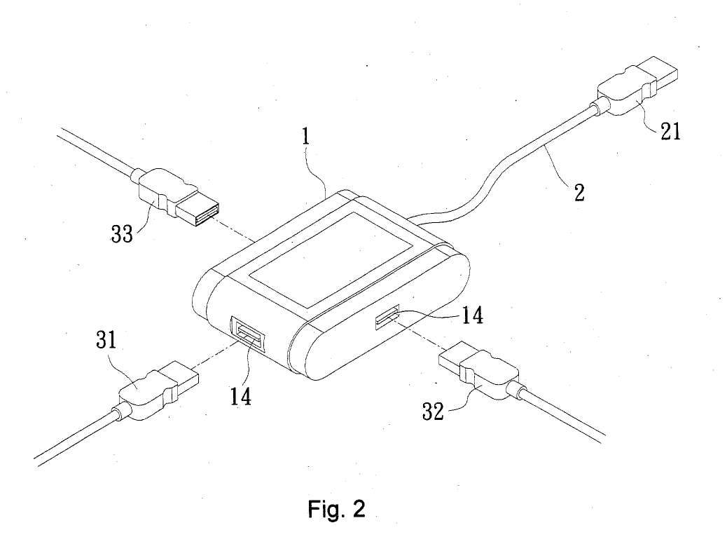

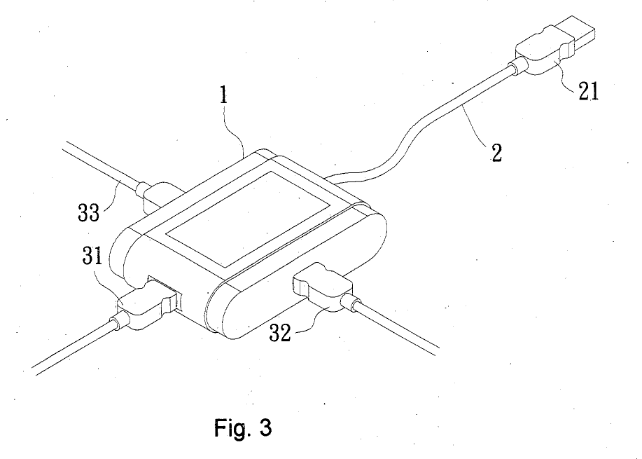

Please refer to FIG. 2 and FIG. 3. FIG. 2 is a perspective diagram of the hub structure separated from the connection lines, and FIG. 3 is a perspective diagram of the hub structure connected to the connection lines. The connecting head 21 at one end of the transmission line 2 is connected to the corresponding inserting hole of the computer, and the other end of it is connected to the body 1. The connecting hole 14 installed on the side of the body 1 is used for being connected to a wireless keyboard connection line 31, a wireless mouse connection line 32 or other wireless device connection line 33 of the peripheral device for the computer. Therefore, the hub structure can supply power to the peripheral device for the computer.

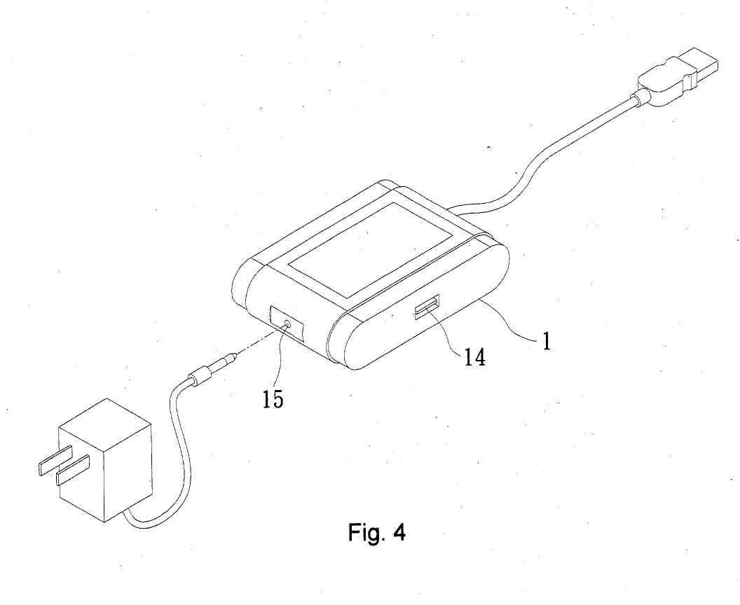

Please refer to FIG. 4. FIG. 4 is a perspective diagram of another embodiment according to the present invention. The connecting hole 14 on one side of the body 1 can be replaced by a direct current inserting hole 15, or the direct current inserting hole 15 can be further added. The direct current inserting hole 15 is provided for being connected to a rectifier or a transformer. When the hub structure is not connected to the computer or when the computer is turned off, the rectifier or transformer can be connected to the hub structure so that the hub structure and externally connected devices can be operated normally.

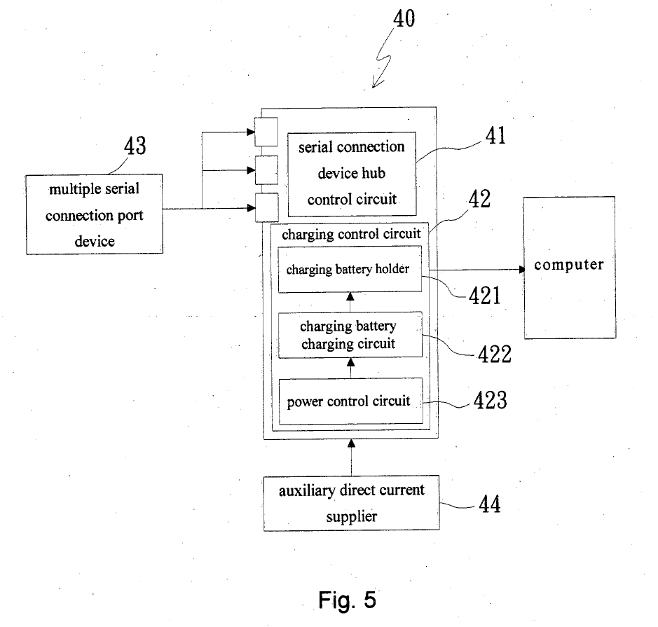

Please refer to FIG. 5. FIG. 5 is a block diagram of the circuit structure 40 of the body 1 according to the present invention. The circuit structure 40 of the body 1 circuit structure comprises a serial connection device hub control circuit 41 and a charging control circuit 42. The serial connection device hub control circuit 41 is provided for being connected to the multiple serial connection port device 43. The multiple serial connection port device 43 can be an interface of USB, PS2 or serial communication port, and is used for being connected to the peripheral device for the computer, such as a wireless keyboard, a wireless mouse or a wireless device. When the multiple serial connection port device 43 is connected to the computer, it is used for being the interface between the computer and the multiple serial port devices. When the multiple serial connection port device 43 is not connected to the computer or the computer is turned off, it is provided to transmit the data among the multiple serial port devices. The charging control circuit 43 comprises a charging battery holder 421, a charging circuit 422 and a power control circuit 423. The charging control circuit 42 is connected to the computer for supplying power to the serial connection device hub control circuit 41. The power control circuit 423 of the charging control circuit 42 is connected to an auxiliary direct current supplier 44. When the hub structure is not connected to the computer or the computer is turned off, the hub structure still can be operated normally.

Those skilled in the art will readily observe that numerous modifications and alterations of the device may be made while retaining the teachings of the invention. Accordingly, the above disclosure should be construed as limited only by the metes and bounds of the appended claims.

1. A hub structure having a charging function comprising a body and a transmission line, one end of the transmission line being connected to one side of the body, and the other end being a connecting head, the connecting head being an interface of USB, PS2 or serial communication connection port, the greatest side of the body being formed with a battery tray, and at least one charging battery being installed in the battery tray, a battery tray cover being installed above the battery tray for covering the battery tray, at least one connecting hole being installed on one side of the body, and the connecting hole being an interface of USB, PS2 or serial communication connection port, the connecting hole and the transmission line being separately connected to the inside circuit structure of the body so as to form the hub structure having a charging function.

2. The hub structure having a charging function according to the claim 1, wherein one side of the body further comprises a direct current inserting hole, or the direct current inserting hole is used for replacing the original connecting hole.

3. The hub structure having a charging function according to the claim 1, wherein the inside circuit structure of the body comprises a serial connection device hub control circuit and a charging control circuit, and the serial connection device hub control circuit is used for connecting to a multiple serial connection port device, the multiple serial connection port device can be an interface of USB, PS2 or serial communication port, and the charging control circuit comprises a charging battery holder, a charging circuit and a power control circuit.
